(19) United States
(12) Patent Application Publication
(10) Pub. No.: US 2018/0325074 A1
(43) Pub. Date: Nov. 15, 2018

(54) Portable Toilet Litter Bowl for Cats

(71) Applicant: Traci Danielle Thompson, Orlando, FL (US)

(72) Inventor: Traci Danielle Thompson, Orlando, FL (US)

(21) Appl. No.: 15/594,624

(22) Filed: May 14, 2017

(51) Int. Cl. A01K 1/01

(52) U.S. Cl. CPC A01K 1/0121

(57) ABSTRACT

A portable toilet litter bowl for cats that fits human toilets of all conventional sizes, may be alternately placed in a functional position on flat surfaces, that provides an uncomplicated, space-saving, secure, environmentally friendly cat toilet apparatus. The litter bowl is comprised of a plastic injection molded unitized structure including a flat u-shaped horizontal platform member that provides a comfortable area on which cats may jump, stand and rest their front paws, a central basin extending downwardly from said platform into a conventional human toilet bowl in which flushable cat litter is placed and cats urinate and defecate, a basin opening with a sliding cover system that provides a simple, sanitary method for expelling soiled litter and containing clean litter, a semi-oval shaped internal wall extending upwardly on the back and sides of said platform to prevent cat litter from spilling onto the floor, a semi-oval shaped external wall/base extending downwardly from the top of said internal wall with a base perimeter flange that keeps said toilet litter bowl steady and secure on a conventional human toilet as well as on flat surfaces, and a pawprint shaped handgrip opening adjacent each side therein to provide a simple, quick method for moving said toilet litter bowl on and off a conventional human toilet. Said litter bowl is designed for regular use, not cat toilet training.

### SUMMARY OF THE INVENTION

The aim of the invention is to have a portable cat toilet litter bowl that is easily cooperated with and separated from a conventional human toilet bowl, and saves space, time, effort, money and the environment.

Said portable toilet litter bowl for cats is supported on a conventional human toilet, as well as on its base perimeter flange when placed on flat surfaces.

### DESCRIPTION

The present invention relates to a cat toilet, and more particularly, an uncomplicated, space-saving, secure, sanitary, environmentally friendly toilet litter bowl for cats that is easily portable and may be used on a conventional human toilet as well as in a functional position on flat surfaces.

Numerous cat toilets are known in the prior art. Exemplary of such seats are those described in U.S. Pat. No. 2,053,594 to Minnie (1936), U.S. Pat. No. 2,584,656 to Anderson (1952), U.S. Pat. No. 3,601,093 to Cohen (1971), U.S. Pat. No. 3,656,457 to Houston (1972), U.S. Pat. No. 3,688,742 to Mcgee (1972), U.S. Pat. No. 3,757,738 to Hall (1973), U.S. Pat. No. 3,949,429 to Hall (1976), U.S. Pat. No. 4,231,321 to Cohen (1980), U.S. Pat. No. 4,271,544 to Hammond (1981), U.S. Pat. No. 4,748,700 to Wooten (1988), U.S. Pat. No. 5,117,780 to Wooten (1992), U.S. Pat. No. 5,216,979 to Sallee and Freitas (1993), U.S. Pat. No. 5,458,089 to Rymer (1995), U.S. Pat. No. 6,119,629 to Sicchio (2000), U.S. Pat. No. 6,418,880 to Chiu (2002), U.S. Pat. No. 7,882,805 to Yu (2011), U.S. Pat. No. 7,963,251 to Terence and Fredericks (2011), and U.S. Pat. No. 8,051,804 to Rescate (2011). While these units may be suitable for the purpose to which they address, they would not be as suitable for the purpose of the present invention as hereafter described.

It is known to have cat litter boxes that are used with, or are emptied into, a conventional human toilet bowl. It is also known to have cat training devices that are intended to teach cats to use a conventional human toilet bowl instead of a cat litterbox. Many such devices are elaborate and provide a structure for placement over the toilet bowl comprised of steps, trap doors, and/or weight activated timers for flushing and introducing sanitizing fluids. The inventions disclosed in U.S. Pat. No. 3,601,093 to Cohen (1971), U.S. Pat. No. 3,656,457 to Houston (1972), U.S. Pat. No. 4,231,321 to Cohen (1980), U.S. Pat. No. 4,271,544 to Hammond (1981), U.S. Pat. No. 4,748,700 to Wooten (1988), U.S. Pat. No. 5,117,780 to Wooten (1992), and U.S. Pat. No. 5,216,979 to Sallee and Freitas (1993) comprise variations of such elaborate and complex systems. Other such cat training devices are less complicated and provide a platform for placement over a toilet bowl, sometimes comprised of various inserts or receptacles that are removed periodically to decrease the size of the platform, until a cat can urinate and defecate into a conventional human toilet bowl without the aid of any device. The inventions disclosed in U.S. Pat. No. 3,688,742 to Mcgee (1972), U.S. Pat. No. 7,882,805 to Yu (2011), U.S. Pat. No. 7,963,251 to Terence and Fredericks (2011), and U.S. Pat. No. 8,051,804 to Rescate (2011) comprise variations of such unsophisticated systems. Both elaborate and unsophisticated cat toilet training devices usually fail to teach a cat to use a conventional human toilet without the ongoing aid of a device due to several factors, including the extensive amount of supervision time required by a cat owner throughout the training process, undesirable and unsanitary conditions, a cat's urinary tract problems, and a cat's inability to accomplish the final step due to feeling uncomfortable or frightened.

Other inventions disclose a toilet seat device for attachment to the upper surface of a conventional human toilet bowl that permits dual use of the toilet bowl by humans and cats. Such dual use devices are disclosed in U.S. Pat. No. 3,757,738 to Hall (1973), U.S. Pat. No. 3,949,429 to Hall (1976), and U.S. Pat. No. 5,458,089 to Rymer (1995). U.S. Pat. No. 5,458,089 to Rymer (1995) comprises retractable shelf segments that are biased to reduce the central aperture of a toilet seat for cats and are retractable in response to the weight of a human. U.S. Pat. No. 3,949,429 to Hall (1976) is shallow and oval-shaped, and snap-fits over the upper surface of a conventional human toilet bowl, allowing a conventional human toilet seat to be placed over it for human use.

These dual use devices can be unsanitary and are undesirable to most cat owners. U.S. Pat. No. 3,757,738 to Hall (1973) is a thin, hinged Portable Toilet Litter Bowl for Cats by Traci Thompson platform that is lowered to rest on a conventional human toilet seat when a cat uses the toilet and raised to rest against the flush tank when a human uses the toilet. These devices are not widely used due to concerns about unsanitary conditions and cumbersome configurations.

The prior art known to be most closely related to the present invention in function or in configuration are the inventions disclosed in U.S. Pat. No. 2,053,594 to Minnie (1936), U.S. Pat. No. 2,584,656 to Anderson (1952), U.S. Pat. No. 6,119,629 to Sicchio (2000), and U.S. Pat. No. 6,418,880 to Chiu (2002). U.S. Pat. No. 2,053,594 to Minnie (1936) and U.S. Pat. No. 2,584,656 to Anderson (1952) disclose animal commodes placed on conventional human toilet bowls; however, they have complex mechanisms and are not easily removed for use of a conventional human toilet by humans. Additionally, the Minnie invention is cumbersome and intended for dual use as an animal toilet and bath, and the Anderson invention can only be used on a conventional human toilet, not in a functional position on flat surfaces. U.S. Pat. No. 6,119,629 to Sicchio (2000) and U.S. Pat. No. 6,418,880 to Chiu (2002) have shallow configurations that do not properly contain litter, are not welcoming or comfortable for cats, and, like the Anderson invention, can only be used on a conventional human toilet, not in a functional position on flat surfaces.

In contrast, the present invention is uncomplicated, welcoming and comfortable for cats, easily portable, may be alternately placed in a functional position on flat surfaces, and properly contains flushable litter to prevent unsanitary conditions, time consuming cleanup and wasted cat litter.

Most previously patented devices deal with toilet training for cats, or complex mechanized cat toilets and cat toilet devices that are expensive and have never been exploited commercially, and thus have little or no relevance to the present invention.

### BACKGROUND OF THE INVENTION

The present invention solves numerous problems encountered while utilizing various cat toilet training devices and cat litterboxes, mechanical and otherwise, in a small apartment over a two-year period.

Many cat owners who occupy apartments, mobile homes, recreational vehicles and other small living spaces keep their cat indoors for all or part of the day. This may be to prevent a cat from wandering and becoming lost, being harmed by vehicles, killing native animals, or for other reasons. These cats are unable to urinate and defecate outside and therefore require some type of device that allows them to relieve themselves indoors. The usual solution is to provide a cat litterbox with absorbent material into which a cat may urinate and defecate. This has some disadvantages, including lingering bad odor, space limitations, cumbersome cleanup, unsanitary conditions and use of materials that are harmful to the environment.

A solution utilized less frequently is a temporary cat toilet training device that is intended to train a cat to use a conventional human toilet, eventually without the aid of any device. This has many disadvantages, including particularly time consuming supervision requirements, unstable devices, immobile devices, cumbersome cleanup, a cat urinating and defecating in sinks and bathtubs as well as on floors and furniture, a cat getting urinary tract problems, and the inability of a cat to achieve the final step in training to use a conventional human toilet without the ongoing use of a device. This method is not widely used and contains features and problems that do not encourage its widespread adoption.

The present invention intends to provide a portable toilet litter bowl for cats that is uncomplicated, easily transferred, space-saving, secure, sanitary, environmentally friendly and comfortable for cats.

Another object of the invention is to provide a cat litter bowl that is durable, has a simple mechanical structure, may be fabricated from plastic, and may be retailed at a moderate price as to encourage the widespread use thereof by cat owners, especially those living in small spaces.

### BRIEF DESCRIPTION OF THE DRAWINGS

FIG. 1 shows a 3D view of said portable toilet litter bowl for cats placed in a functional position on a conventional human toilet.

FIG. 2 shows a 3D top view of said portable toilet litter bowl for cats including a flat u-shaped horizontal platform member, a central basin extending downwardly from said platform with a squarely-shaped opening therein, a semi-oval shaped internal wall extending upwardly around the back and sides of said platform with a pawprint shaped handgrip opening adjacent each side therein and four door slider rivets therein, and a semi-oval shaped external wall/base extending downwardly from the top of said internal wall with a pawprint handgrip opening adjacent each side therein and base perimeter flange thereon.

FIG. 3 shows a back view of said door slider including the plate, door slider nubs, door slider locks and door slider rivet holes.

FIG. 4 shows a 3D front view of said basin door including the door plate, door stick and door ball topper.

FIG. 5 shows a 3D front view of said door slider rivet.

FIG. 6 shows a 3D top view of said portable toilet litter bowl for cats including a flat u-shaped horizontal platform member, a central basin extending downwardly from said platform with a squarely-shaped opening therein, a semi-oval shaped internal wall extending upwardly around the back and sides of said platform with a pawprint shaped handgrip opening adjacent each side therein and four door slider rivets therein, a semi-oval shaped external wall/base extending downwardly from the top of said internal wall with a pawprint handgrip opening adjacent each side therein and base perimeter flange thereon, a basin door with door stick that extends upwardly through a door stick hole in the top of said wall, and a door ball topper that screws onto the door stick.

FIG. 7 shows a top view of said portable toilet litter bowl for cats including a flat u-shaped horizontal platform member, a central basin extending downwardly from said platform with a squarely-shaped opening therein, a semi-oval shaped internal wall extending upwardly around the back and sides of said platform with a pawprint shaped handgrip opening adjacent each side therein and four door slider rivets therein, a semi-oval shaped external wall/base extending downwardly from the top of said internal wall with a pawprint handgrip opening adjacent each side therein and base perimeter flange thereon, a basin door stick that extends upwardly through a door stick hole in the top of said wall, and a door ball topper that screws onto the door stick.

FIG. 8 shows a 3D bottom view of said portable toilet litter bowl for cats including a flat u-shaped horizontal platform member, a central basin extending downwardly from said platform bottom with a squarely-shaped opening therein, a semi-oval shaped internal wall extending downwardly around the back and sides of said platform bottom, adjacent door sliders above the basin opening attached to the rear wall by door slider rivets, a semi-oval shaped external wall/base extending downwardly from the top of said internal wall with a pawprint handgrip opening on one side therein and base perimeter flange thereon, a basin door and door stick that extends upwardly through a door stick hole in the top of said wall, and a door ball topper that screws onto the door stick.

FIG. 9 shows a front view of said portable toilet litter bowl for cats including a flat platform member, an internal wall extending upwardly with door slider rivets therein, a central basin wall extending downwardly with a basin opening therein, an external wall/base extending downwardly from the top of said internal wall with a pawprint handgrip opening adjacent each side therein and base perimeter flange thereon, a basin opening door stick that extends upwardly through a door stick hole in the top of said wall, and a door ball topper that screws onto the door stick.

FIG. 10 shows a side view of said portable toilet litter bowl for cats including an external wall/base extending downwardly from the top of said internal wall with a pawprint handgrip opening therein and base perimeter flange thereon, and a basin door ball topper.

FIG. 11 shows a back view of said portable toilet litter bowl for cats including a central basin extending downwardly with a squarely-shaped opening therein, adjacent door sliders above the basin opening attached to the rear internal wall by door slider rivets, a semi-oval shaped external wall/base extending downwardly from the top of said internal wall with a base perimeter flange thereon, a basin door plate and door stick that extends upwardly through a door stick hole in the top of said wall, and a door ball topper that screws onto the door stick.

FIG. 12 shows a 3D bottom view of said portable toilet litter bowl for cats including a flat u-shaped horizontal platform member, a central basin extending downwardly from said platform with a squarely-shaped opening therein, a semi-oval shaped internal wall extending upwardly around the back and sides of said platform, adjacent door sliders above the basin opening attached to the rear internal wall by door slider rivets, a semi-oval shaped external wall/base extending downwardly from the top of said internal wall with a pawprint handgrip opening adjacent each side therein and base perimeter flange thereon, a basin door and door stick that extends upwardly through a door stick hole in the top of said wall at the back, and a door ball topper that screws onto the door stick.

FIG. 13 shows a front view of said door slider including the door slider plate and door slider rivet holes.

FIG. 14 shows a back view of said door slider including the door slider plate, door slider nubs, door slider locks, door slider rivet holes and door slider stop.

FIG. 15 shows an enlarged view of said door slider including the door slider plate, door slider nubs, door slider locks, door slider rivet hole and door slider stop.

FIG. 16 shows a front view of said door slider rivet.

FIG. 17 shows a front view of said door ball topper.

FIG. 18 shows a bottom view of said door ball topper including the door ball screw hole.

FIG. 19 shows a 3D front view of the basin door, including the basin door plate with attached basin door stick and basin door ball screw, and detached basin door ball topper.

### DETAILED DESCRIPTION OF PREFERRED AND OTHER EMBODIMENTS

Reference will now be made in detail to the preferred embodiment of the invention, an example of which is illustrated in the accompanying drawings. While the invention will be described in conjunction with that preferred embodiment, it will be understood that it is not intended to limit the invention to one preferred embodiment. On the contrary, it is intended to cover alternatives, modifications, and equivalents as may be included within the spirit and scope of the invention as defined by the appended claims.

An embodiment of the invention includes a litter bowl base unit 1. The base unit 1 has a flat u-shaped horizontal platform 6. Extending upwards from the platform 6 is a vertical semi-oval shaped peripheral internal wall 3. The rear internal wall 3 has adjacent door slider rivet holes 30 located just above the basin opening 16. Located in the center of horizontal platform 6 is an oval-shaped basin 11 extending downwardly. This basin 11 is defined by a downwardly extending wall portion 14 with a small squarely-shaped opening 16 at the back, and a horizontally extending bottom portion 12 that runs parallel to the platform 6. Ideally, the basin bottom 12 sits on the same horizontal plane as the base perimeter flange 23. Extending downwards from the top of the internal wall 3 is a vertical semi-oval shaped peripheral external wall/base 4. Both the internal wall 3 and external wall/base 4 have adjacent pawprint shaped handgrip openings 17 on each side of the litter bowl base unit 1 to provide a quick and easy method for moving said toilet litter bowl on and off a conventional human toilet.

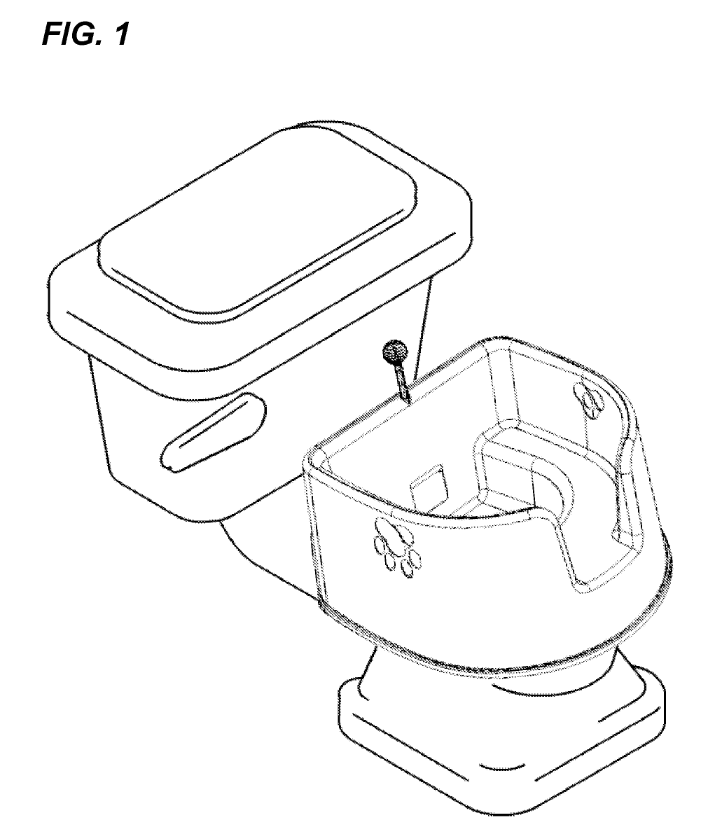

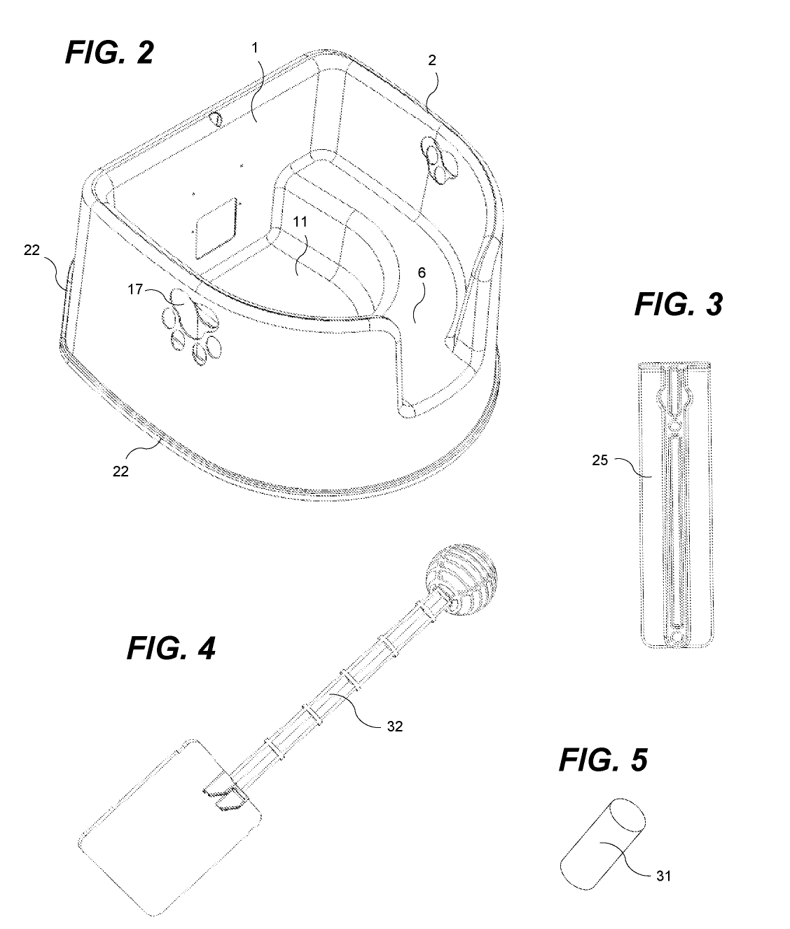

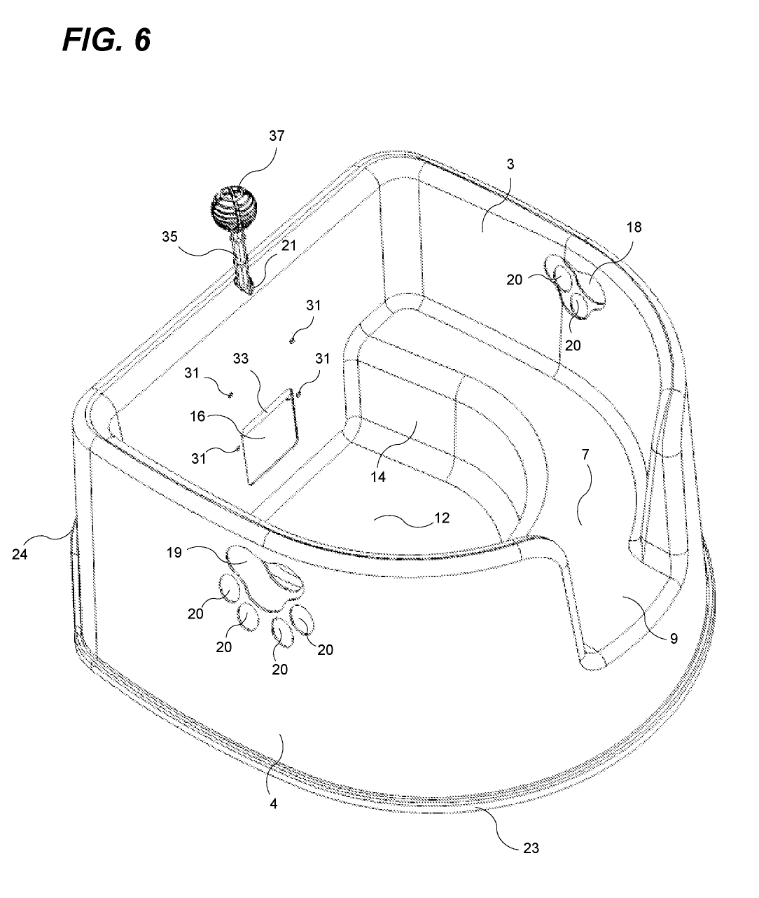

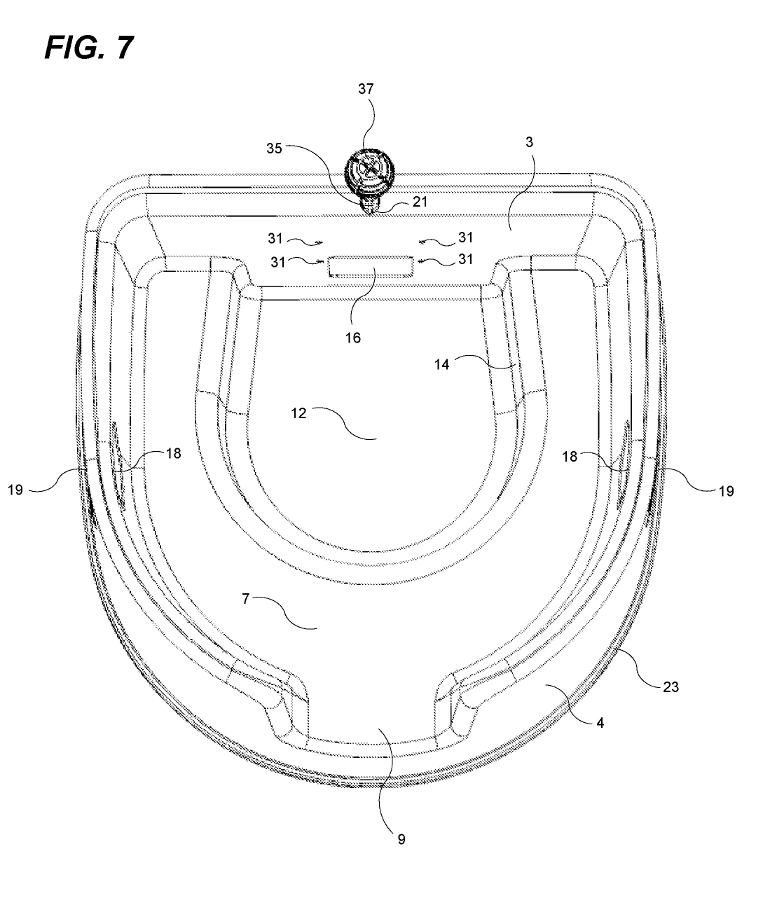

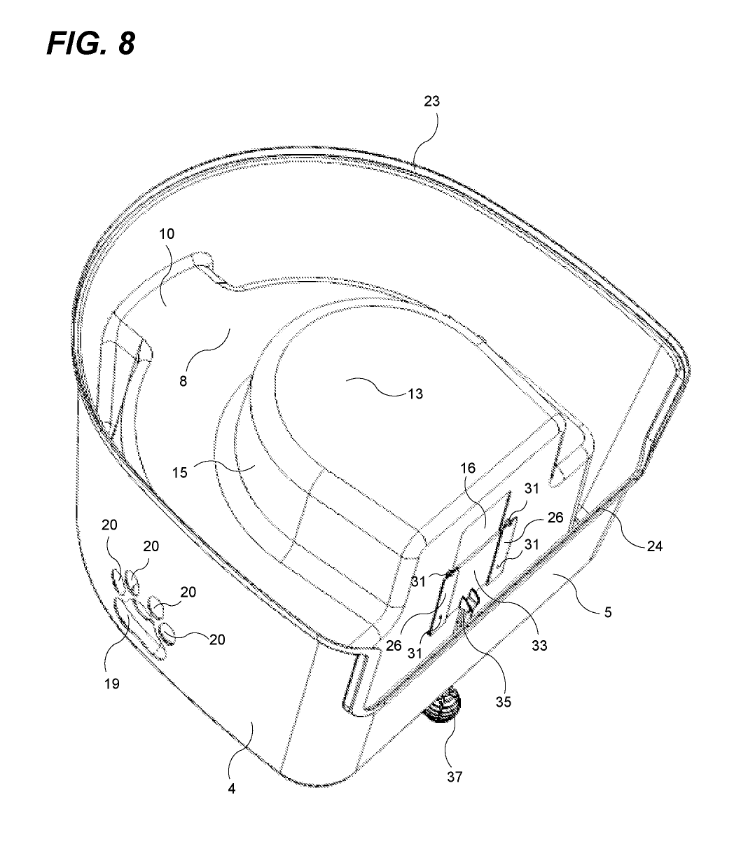

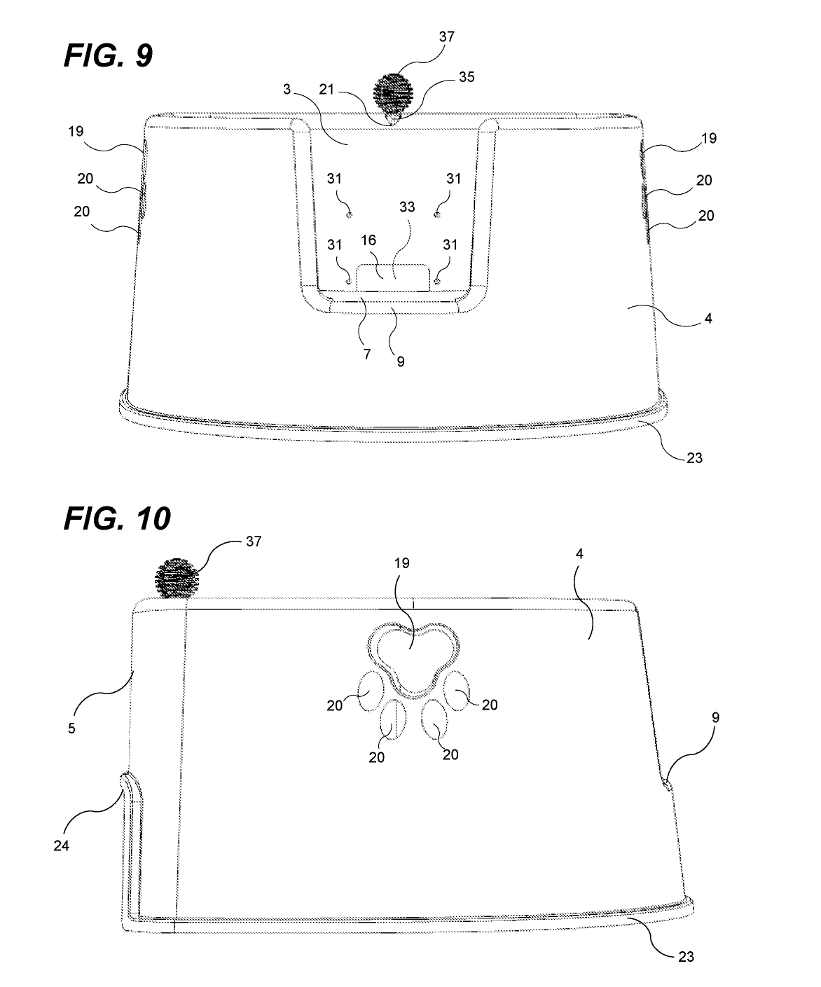

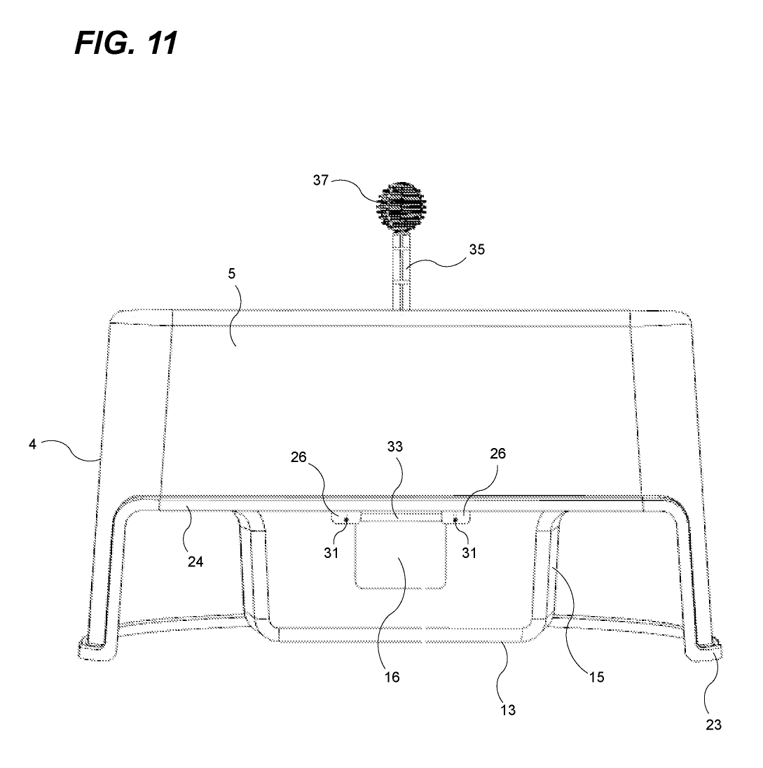

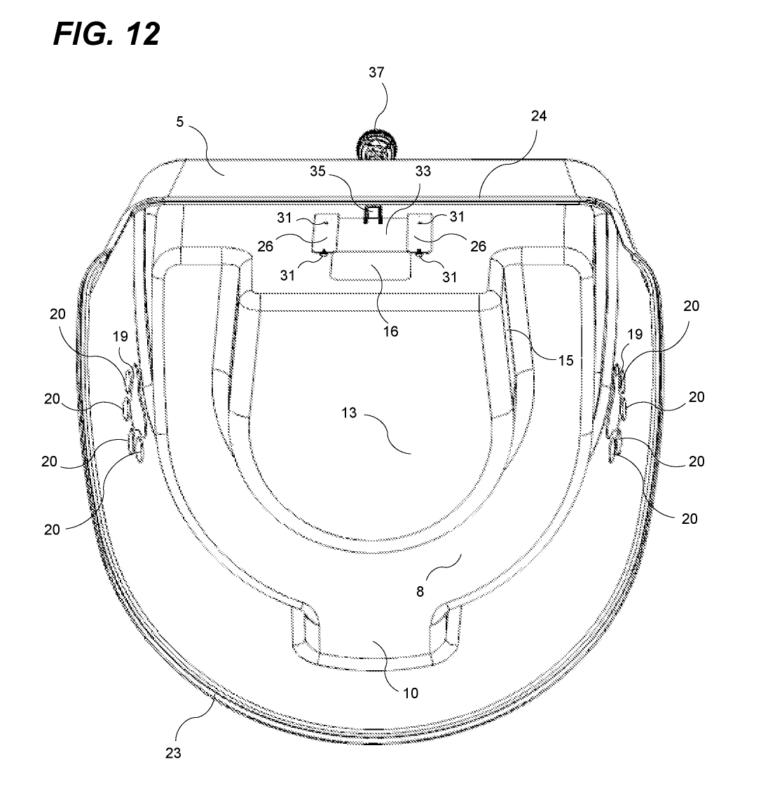

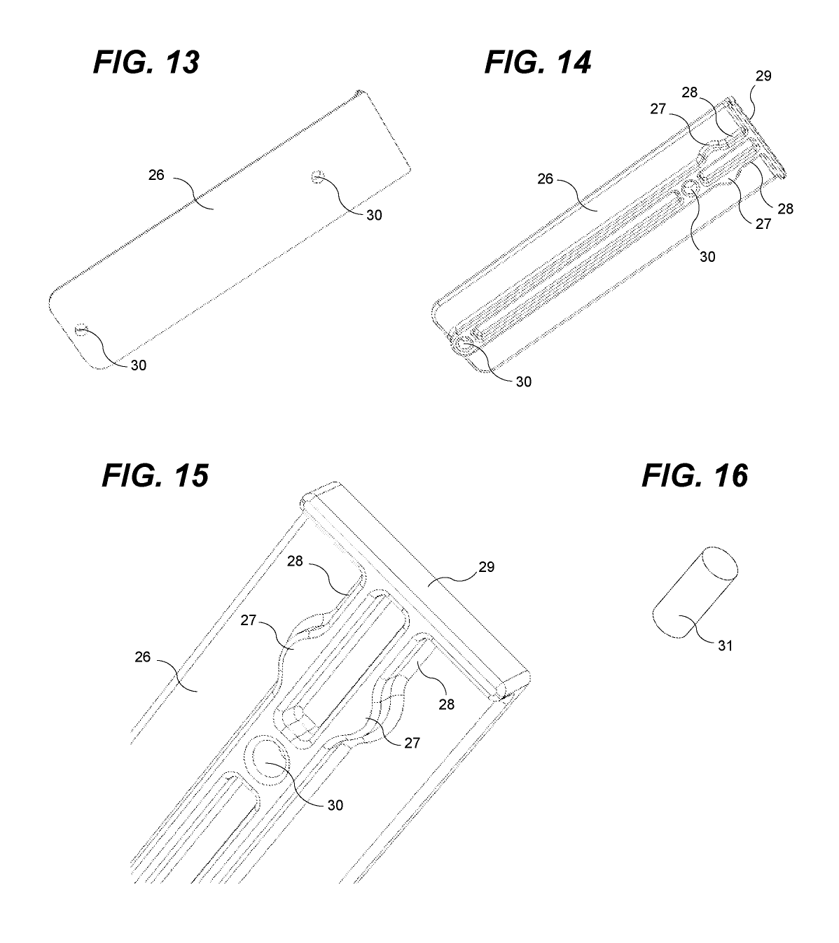

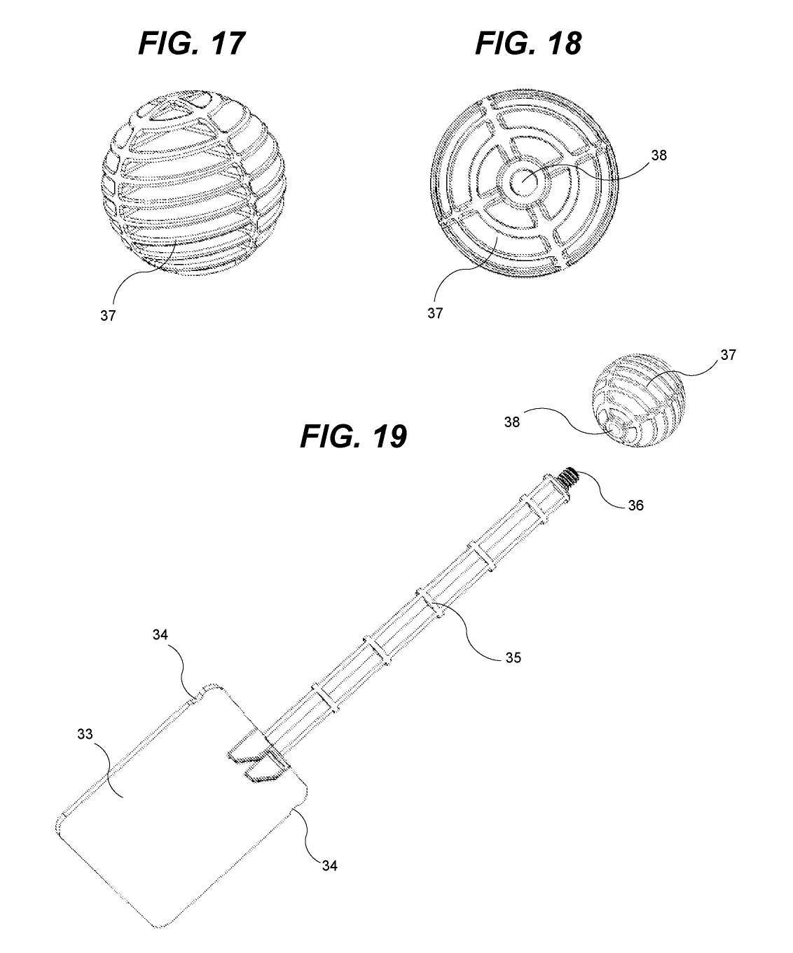

The unitized structure is designed to fit conventional human toilets of all sizes, as seen in FIG. 1. For clarity, the bottom of the platform entrance 10 and rear wall flange 24 sit directly on a toilet bowl rim with the toilet seat in an upward position. When the unitized structure is cooperated with a conventional human toilet, the basin 11 extends downwardly into the toilet bowl, with the lower basin bottom 13 sitting above water level, and the peripheral external wall/base 4 extends downwardly over the outside of the toilet bowl.

The external wall/base 4 has a bottom perimeter flange 22. The external wall/base 4, in combination with the bottom perimeter flange 22, keep the unitized structure stable and secure on a convention human toilet as well as in a functional position on flat surfaces.

The basin door 32 includes a basin door plate 33 with attached basin door stick 35, and a detached basin door ball topper 37. The basin door plate 33 extends upwardly between the rear wall 5 and door sliders 25 while the top of the basin door stick 35 extends upwardly through the door stick hole 21 in the top of the wall 2 and screws into the basin door ball topper 37 with the basin door stick screw 36. The basin door plate 33 has small semi-circularly shaped basin door nub receptacles 34 adjacent each side of said basin door plate 33 that accommodate the door slider nubs 27 with a tight fit. When the litter bowl is fully assembled with the basin door 32 attached, gripping and pulling up on the basin door ball topper 37, until the basin door nub receptacles 34 accommodate the door slider nubs 27, exposes the basin opening 16 for scooping soiled cat litter and excrement into a conventional human toilet bowl in a simple, sanitary manner. Alternately, pushing down on the basin door ball topper 37 until it sits on top of the rear wall 5 covers the basin opening 16 in order to contain flushable cat litter, preventing toilet clogs and wasted cat litter.

It will be appreciated that every part, including the base unit 1, door slider 25, door slider rivet 31 and basin door 32, may be formed by a plastic injection molding process.

It is relatively easy to train a cat to urinate or defecate into a tray placed on the ground that contains suitable absorbent material. The cat will urinate or defecate and cover its waste with the absorbent material, an instinctive action. Accordingly, flushable cat litter is placed in the basin 10 to a suitable depth, about one inch, and the unitized structure is placed on the floor next to a conventional human toilet to introduce it to a cat.

After a cat is comfortable with using the litter bowl unit on the floor, the cat is trained to use the litter bowl unit while in place on a conventional human toilet, as seen in FIG. 1. The toilet seat and lid (not shown) are raised and the unitized structure is placed directly on the rim of a conventional human toilet. Since the cat is already comfortable with using the unitized structure, it is relatively easy to train the cat to use it while placed on a conventional human toilet as opposed to the floor. The cat is then comfortable with using the portable unitized structure on the toilet as well as on the floor.

The foregoing description of the preferred embodiment of the invention has been presented for purposes of illustration and description. It is not intended to be exhaustive or to limit the invention to the precise form disclosed, and many modifications and variations are possible in light of the above teaching. The preferred embodiment was chosen and described in order to best explain the principles of the invention and its practical applications to thereby enable others skilled in the art to best utilize the invention and various embodiments, and with various modifications as are suited to the particular use contemplated. It is intended that the scope of the invention be defined only by the appended claims.

1. An uncomplicated portable toilet litter bowl that permits use of a conventional human toilet by cats, may be alternately placed in a functional position on a flat surface, said toilet litter bowl comprising:
a flat u-shaped horizontal platform member, a central basin extending downwardly from said platform with a squarely-shaped opening therein, a semi-oval shaped internal wall extending upwardly around the back and sides of said platform with a handgrip opening adjacent each side therein and four door slider rivet holes therein, and a semi-oval shaped external wall/base extending downwardly from the top of said internal wall with a handgrip opening adjacent each side therein and base perimeter flange thereon.
a manual sliding basin opening and closing system comprised of a squarely-shaped opening in said basin, a door with attached door stick that extends upwardly through door sliders above and adjacent each side of said basin opening and through a door stick hole in the top of said wall, and a door ball topper that screws onto the door stick.

2. The portable toilet litter bowl of claim 1 wherein said toilet litter bowl provides an uncomplicated, space-saving, secure, sanitary, environmentally friendly cat toilet apparatus that is also welcoming and comfortable for cats.

3. The portable toilet litter bowl of claim 1 wherein said platform provides a comfortable area on which cats may jump, stand and rest their front paws while urinating, defecating or both in said basin.

4. The portable toilet litter bowl of claim 1 wherein said unit has a semi-oval shaped external wall/base extending downwardly with a base perimeter flange so that when said toilet litter bowl is removed from a conventional human toilet, it may be alternately placed in a functional position on a flat surface for use by cats.

5. The portable toilet litter bowl of claim 1 wherein said external wall/base extending downwardly from the top of said internal wall serves as weight and a bumper to keep said toilet litter bowl steady and secure on a conventional human toilet.

6. The portable toilet litter bowl of claim 1 wherein said basin extends downwardly from said platform into a conventional human toilet bowl whereby flushable cat litter is contained and a cat may urinate, defecate or both without being frightened or uncomfortable.

7. The portable toilet litter bowl of claim 1 wherein said walls prevent cat litter from spilling onto the floor, saving time, effort and money.

8. The portable toilet litter bowl of claim 1 wherein said walls have said handgrip openings adjacent each side therein to provide a quick and easy method for moving said toilet litter bowl on and off a conventional human toilet.

9. The portable toilet litter bowl of claim 1 wherein said basin door is manually slid up using said door ball topper, held in an upward position by door slider nubs on the door sliders and door nub receptacles on the door, in order to uncover said basin opening for scooping soiled cat litter and excrement into a conventional human toilet bowl in a simple, sanitary manner.

10. The portable toilet litter bowl of claim 1 wherein said basin door is manually slid down using said door ball topper in order to contain clean litter in said basin, saving money and preventing clogs in a conventional human toilet.

11. A portable toilet litter bowl, substantially as herein described in the drawings.
